(19) United States
(12) Patent Application Publication
(10) Pub. No.: US 2006/0285208 A1
(43) Pub. Date: Dec. 21, 2006

(54) OPTICAL MULTILAYER THIN-FILM SYSTEM

(75) Inventor: Wen-hao Huang, Taichung (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Optical Co., Inc., Taichung (TW)

(21) Appl. No.: 11/424,262

(22) Filed: Jun. 15, 2006

(30) Foreign Application Priority Data
Jun. 15, 2005 (TW) 094119911

(51) Int. Cl. G02B 27/46

(52) U.S. Cl. 359/559; 359/586

(57) ABSTRACT

An optical multilayer thin-film system (11) includes a number of high refractive index layers (13), and a number of low refractive index layers (14) alternately laminated with the high refractive index layers. Each high refractive index layer has an optical thickness larger than that of each low refractive index layer. When such a multilayer thin-film system is applied to an optical element, spectral shift with respect to variation of the incident light angle is significantly reduced.

### BACKGROUND OF THE INVENTION

1. Field of the Invention

The present invention relates to a thin-film system, and in particular to a multilayer thin-film system for use with an optical element, such as an optical filter and lens.

2. Description of Prior Art

Optical film coatings have been widely applied to lenses or optical filters in projectors, traditional cameras, digital cameras, mobile phones and astronomical telescopes to achieve various optical functions. These optical functions include UV absorption, anti-reflection, color filtering, IR cutting, and so on. Thereinafter, the optical filter will be taken as an example to introduce the thin-film system of optical film coating and corresponding optical functions achieved. The so-called optical filter is a device that is designed according to the light absorption and interference theory, and selectively transmits light having certain properties (often, a particular range of wavelengths, namely colors of light, or polarizations), while blocking the remainder components of light.

Filters can be generally classified into two types: absorption filters and interference filters. An absorption filter absorbs a specific range of wavelengths and transmits the remainder, for example, a piece of colored filter glass. The absorption filter has the disadvantages of poor monochromatic performance and large light loss. A special type of absorption filter is the cut-off filter, which is called an absorption cut-off filter or a non-interference cut-off filter. The disadvantages of an absorption cut-off filter are that the cut-off wavelength λ_{c} is not adjustable and the steepness of the cut-off slope is not sufficient. These make the absorption cut-off filter impractical in application.

An interference filter comprises a multilayer of thin films to create constructive interference caused by phase difference, so that only a specific range of wavelengths is transmitted and all the other wavelengths are reflected. When the interference effect of thin films is applied to a cut-off filter, an interference cut-off filter can be obtained. The above-mentioned disadvantages of the absorption cut-off filter can be overcome by the interference cut-off filter. However, the cut-off wavelength λ_{c} of the interference filter is very sensitive to the incident angle of the light as the light enters the filter. When light is incident at an oblique angle, the position of the cut-off wavelength or center wavelength of the interference filter with multilayer thin films, such as an interference cut-off filter, is shifted towards shorter wavelengths, the peak transmittance of the interference filter varies accordingly, and even the cut-off slope also shifts. This is because that, as the incident light changes from normal incidence to oblique incidence, the optical path difference is decreased. That is, the effective layer thickness becomes smaller. The optical thickness of the film layer changes from Nd to Nd cos θ, and the phase thickness of the film layer δ=2πNd cos θ/λ. Accordingly, it can be observed that the center wavelength shifts to the shorter wavelengths.

FIG. 1 illustrates a multilayer thin-film system 81 of a conventional interference cut-off filter 80, which comprises a plurality of high and low refractive indexes layers 83, 84 alternately laminated on a glass substrate 82 (BK-7). Here, BK-7 is a trade name that designates the type of glass material composing the substrate 82. The optical thickness of each high refractive index layer (TiO₂) 83 is equal to that of each low refractive index layer (SiO₂) 84. The optical thickness is defined as the physical thickness “d” of the layer multiplied by the refractive index “N” of the material. When the center wavelength of the incident light is 744nm, the optical thickness of each high or low refractive index layer 83, 84 is designed to be 0.25. The optical thickness and the material of each layer of such a conventional multilayer thin-film system 81 are listed in Table 1 as provided below.

TABLE 1

| Substrate | BK-7 | Optical Thickness |
|---|---|---|
| First Layer | TiO₂ | 0.25 |
| Second Layer | SiO₂ | 0.25 |
| Third Layer | TiO₂ | 0.25 |
| Fourth Layer | SiO₂ | 0.25 |
| — | — | — |
| — | — | — |
| Twenty-Fourth Layer | SiO₂ | 0.25 |
| | Air | |

FIG. 2 shows spectral transmission curves of the above conventional multilayer thin-film system 81 at different incident angles. When light is incident at 0°, as shown in Curve A of FIG. 2, the wavelength at the transmittance of 50 percentages is 650.3nm. When light is incident at 25°, as shown in Curve B of FIG. 2, the wavelength at the transmittance of 50 percentages becomes 632.7 nm. Accordingly, the spectral shift with variation of incident angle is 17.6 nm. Such a spectral shift tends to vary the color being displayed, and thus adversely affects the optical performance of the optical filter with the above multilayer thin-film system disposed thereon.

To ensure reliable optical performance of an optical filter with multilayer thin-films, the optical thickness of each layer is generally required to be adjusted. Chinese Invention Patent No. 1146734C discloses a super-narrow band-pass filter and the method for modulating optical thickness of film layers of the same. The optical thickness of the film layers is varied at random by using random numbers generated in a computer and further selected to achieve optimum optical performance. These designed layer thickness fluctuations significantly reduce performance degradation caused by undesired minor thickness deviations resulting from the thickness fluctuation during coating process in conventional filters, and further ease difficulties in producing such a super-narrow band-pass filter. However, such a random multiplayer thin-film system is rather complex in design, which requires three layers of materials of different refractive indexes and more than sixty layers to be laminated. In addition, similar to the conventional filter film design, this random multiplayer thin-film system still encounters shifts of the transmittance peak. The greater the random degree of the film layer thickness fluctuations, the more the transmittance peak shifts away from the designed position.

Chinese Invention Patent No. 1189763C discloses another super-narrow band-pass filter including two identical substrates. Opposing side surfaces of the two substrates are coated with identical random multilayer thin-films. A plurality of special micro spheres is adhered between the two films around the periphery thereof, whereby a vacuum space is defined between the two substrates. The height of the vacuum space can be adjusted by pressing the deformable micron spheres, so as to adjust the position of the transmittance peak of the filter to the designed position.

However, the above-mentioned random multiplayer thin-film systems for filters still cannot address the problem of spectral shifts with variations of incident angle, and thus are not suitable for being employed as the film system for an interference cut-off filter.

Accordingly, to address the spectral shift problem, it is necessary to provide a new multilayer thin-film system for optical elements.

### SUMMARY OF THE INVENTION

The primary object of the present invention is to provide an optical multilayer thin-film system that ensures little spectral shifts with variation of the incident light angle and thus little color distortion or deviation.

Another object of the present invention is to provide an optical element having a multilayer thin-film system that reduces spectral shifts with variation of the incident light angle, so as to ensure reliable optical performance of the optical element.

To achieve the above objects of the present invention, a multilayer thin-film system in accordance with the present invention comprises a plurality of high refractive index layers, and a plurality of low refractive index layers alternately laminated with the plurality of high refractive index layers. Each high refractive index layer has an optical thickness larger than that of each low refractive index layer. When such a multilayer thin-film system is applied to an optical element, spectral shifts with variation of the incident light angle are significantly reduced.

The multilayer thin-film system is applicable on an interference cut-off filter.

Preferably, titanium oxide (TiO₂) is selected to form the high refractive index layer, and silica oxide (SiO₂) is selected to form the low refractive index layer. When the center wavelength of the incident light is 744 nm, the optical thickness of each high refractive index layer is designed to be 0.35, and the optical thickness of each low refractive index layer is 0.138. The present multilayer thin-film system includes 24 high and low refractive index layers in total.

The present invention employs a plurality of high and low refractive index layers alternately laminated with each other. Each high refractive index layer is designed to have an optical thickness larger than that of the low refractive index layer. This significantly increases spectral reliability of the present multilayer thin-film system independent of the variation of incident light angle, and thus uniformity of color distribution.

### BRIEF DESCRIPTION OF THE DRAWINGS

The present invention may best be understood through the following description with reference to the accompanying drawings, in which:

FIG. 1 is a cross-sectional view of an interference cut-off filter with a conventional multilayer thin-film system disposed thereon;

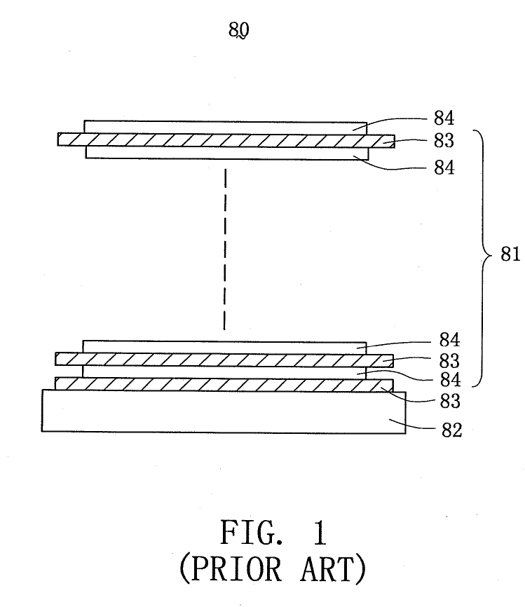

FIG. 2 is a comparative graph showing spectral transmittance curves of the conventional and the present multilayer thin-film systems obtained at different incident angles; and

FIG. 3 is a cross-sectional view of an interference cut-off filter with a multilayer thin-film system in accordance with the present invention disposed thereon.

### DETAILED DESCRIPTION OF THE PREFERRED EMBODIMENT

In the preferred embodiment of the present invention as discussed below, an interference cut-off filter is taken as an example to introduce the present multilayer thin-film system. However, it is apparent to those having ordinary skills in the art that the present invention is also applicable to multilayer thin-film system of other optical elements, such as lenses.

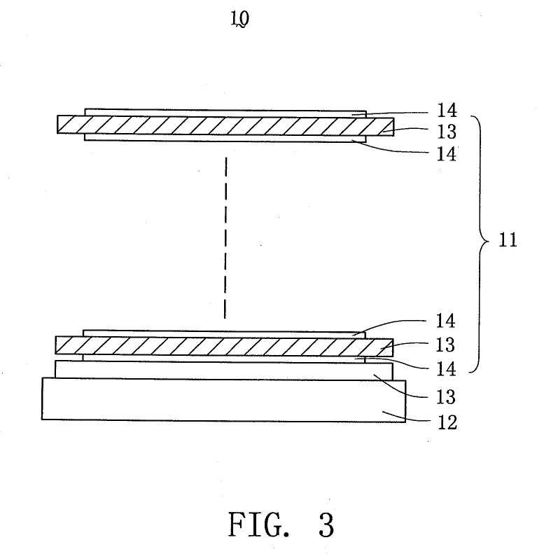

Referring to FIG. 3, a multilayer thin-film system 11 in accordance with the present invention, which is use for an optical element, such as the interference cut-off filter 10, comprises a substrate 12 (BK-7), a plurality of layers 13 formed of high refractive index material, such as TiO₂, and a plurality of layers 14 formed of low refractive index material, such as SiO₂. The high and low refractive index layers 13, 14 are alternately laminated on the substrate 12, and are designed to have different optical thickness. The optical thickness is defined as the physical thickness “d” of the layer multiplied by the refractive index “N” of the material. Each high refractive index layer 13 has an optical thickness larger than that of each low refractive index layer 14. When the center wavelength of the incident light is 744 nm, the optical thickness of each high refractive index layer 13 is designed to be 0.35, and the optical thickness of each low refractive index layer 14 is designed to be 0.138. The optical thickness and the material of each layer of the multilayer thin-film system 11 are listed in Table 2 as provided below.

TABLE 2

| Substrate | BK-7 | Optical Thickness |
|---|---|---|
| First Layer | TiO₂ | 0.35 |
| Second Layer | SiO₂ | 0.138 |
| Third Layer | TiO₂ | 0.35 |
| Fourth Layer | SiO₂ | 0.138 |
| — | — | — |
| — | — | — |
| Twenty-Fourth Layer | SiO₂ | 0.138 |
| | Air | |

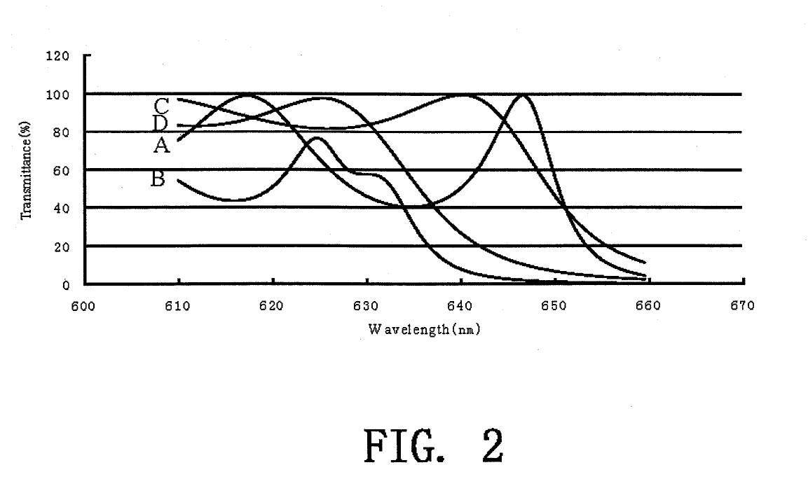

FIG. 2 shows spectral transmission curves of the present optical multilayer thin-film system 11 obtained at different incident angles. When light is incident at 0°, as indicated by Curve C of FIG. 2, the wavelength at the transmittance of 50% is 649.5 nm. When light is incident at 25°, as indicated by Curve D of FIG. 2, the wavelength at the transmittance of 50% becomes 635.6 nm. Accordingly, under the same conditions, the spectral shift of the present invention with variation of incident angle is 13.9 nm, which is markedly smaller than that of the conventional multilayer thin-film system 81 as discussed before. The greater the optical thickness difference between the high and low refractive index layers 13, 14 is, the little the spectral shift with variation of the incident light angle is.

As the alternately laminated high and low refractive index layers 13, 14 of the multilayer thin-film system 11 are designed to have different optical thickness, spectral shift with variation of incident light angle can be significantly reduced, and thus uniform color distributions can be ensured. When the multilayer thin-film system 11 is applied to other optical elements, such as projectors, conventional cameras, digital cameras, and lenses for mobile phones, color deviations or differences can be reduced to the minimum level.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multilayer thin-film system comprising a plurality of high refractive index layers each having a first optical thickness, and a plurality of low refractive index layers each having a second optical thickness, the high and low refractive index layers being alternately laminated with each other, the first optical thickness being larger than that of the second optical thickness.

2. The multilayer thin-film system as claimed in claim 1, wherein the multilayer thin-film system is applied to an interference cut-off filter.

3. The multilayer thin-film system as claimed in claim 1, wherein the high refractive index layer is formed of titanium oxide, and the low refractive index layer is formed of silica oxide.

4. The multilayer thin-film system as claimed in claim 3, wherein, when the center wavelength of the incident light is 744 nm, the optical thickness of each high refractive index layer is 0.35, the optical thickness of each low refractive index layer is 0.138, and the total number of the high and low refractive index layers is 24.

5. The multilayer thin-film system as claimed in claim 1, wherein the multilayer thin-film system is applied to a lens.

6. An optical element comprising a substrate and a multilayer thin-film system disposed on the substrate, the multilayer thin-film system comprising a plurality of high refractive index layers, and a plurality of low refractive index layers alternately laminated with the high refractive index layers, each high refractive index layer having an optical thickness larger than that of each low refractive index layer.

7. The optical element as claimed in claim 6, wherein the optical element is an interference cut-off filter.

8. The optical element as claimed in claim 6, wherein the optical element is a lens.

9. The optical element as claimed in claim 6, wherein the high refractive index layer is formed of titanium oxide, and the low refractive index layer is formed of silica oxide.

10. The optical element as claimed in claim 9, wherein, when the center wavelength of the incident light is 744 nm, the optical thickness of each high refractive index layer is 0.35, the optical thickness of each low refractive index layer is 0.138, and the total number of the high and low refractive index layers is 24.
